(19) United States
(12) Patent Application Publication
(10) Pub. No.: US 2026/0119816 A1
(43) Pub. Date: Apr. 30, 2026

(54) INFORMATION PROCESSING APPARATUS, INFORMATION PROCESSING METHOD, AND NON-TRANSITORY RECORDING MEDIUM

(71) Applicant: NEC Corporation, Tokyo (JP)

(72) Inventors: Takashi SHIBATA, Tokyo (JP); Masahiro Yamaguchi, Tokyo (JP); Takuya Ogawa, Tokyo (JP); Toshinori Hosoi, Tokyo (JP); Yuichi Abe, Tokyo (JP); Shoko Wakizaka, Tokyo (JP); Anri Sueyoshi, Tokyo (JP); Shoichi Yonekura, Tokyo (JP); Kensaku Onda, Tokyo (JP); Eriko Kondo, Tokyo (JP); Yuki Hanzawa, Tokyo (JP); Eisuke Tsuda, Tokyo (JP); Rie Iwasaki, Tokyo (JP); Kazuto Takizawa, Tokyo (JP); Takashi Takeuchi, Tokyo (JP)

(73) Assignee: NEC Corporation, Tokyo (JP)

(21) Appl. No.: 19/352,730

(22) Filed: Oct. 8, 2025

(30) Foreign Application Priority Data
Oct. 29, 2024 (JP) 2024-190024

(51) Int. Cl. G06F 40/40; G06T 7/20; G06T 11/20

(52) U.S. Cl. CPC G06F 40/40; G06T 7/20; G06T 11/23; G06T 2207/20081; G06T 2207/30241

(57) ABSTRACT

The information processing apparatus includes a target detection unit for detecting a target existing in a space using sensor information indicating a sensing result by a sensor that senses the space, a target tracking unit for tracking the target detected by the target detection unit, a text generation unit for generating a text describing a trajectory of the target using a tracking result by the target tracking unit, environmental information regarding an environment of the target, and spatial information indicating the space, and an output unit for outputting an image representing a trajectory of the target in the space and the text generated by the text generation unit.

### INCORPORATION BY REFERENCE

This application is based upon and claims the benefit of priority from Japanese patent application No. 2024-190024, filed on Oct. 29, 2024, the disclosure of which is incorporated herein in its entirety by reference.

### TECHNICAL FIELD

The present disclosure relates to an information processing apparatus, an information processing method, and a non-transitory recording medium.

### BACKGROUND ART

A technique for tracking movement of a target such as an object is known. An example of a technique for tracking movement of a target is a technique described in WO 2022/190652 A1, for example. The image capturing apparatus described in WO 2022/190652 A1 images an object, extracts a plurality of feature amounts of the imaged object, determines priorities of the plurality of extracted feature amounts, determines a feature amount according to a height of the priority and an allowable amount of an output destination, and outputs the feature amount and a movement direction in association with each other. A technique for displaying a tracking result of movement of a target is also known.

### SUMMARY

In a case where the tracking result of the movement of the target is displayed, the user can grasp the trajectory of the movement of the target, but there is a problem that it is difficult to determine whether the trajectory is important (whether it is necessary to gaze, etc.) or how important the trajectory is only by checking the displayed trajectory. In particular, for example, in a case where a plurality of trajectories are displayed on one screen, it is difficult for the user to determine which trajectory is important. The technique described in WO 2022/190652 A1 has a similar problem.

The present disclosure has been made in view of the above problems, and an example object of the present disclosure is to provide a technique that facilitates determination of a trajectory of a target by a user.

An information processing apparatus according to an example aspect of the present disclosure includes a target detection means for detecting a target existing in a space using sensor information indicating a sensing result by a sensor configured to sense the space, a target tracking means for tracking a target detected by the target detection means, a text generation means for generating a text describing a trajectory of the target using a tracking result by the target tracking means, environmental information regarding an environment of the target, and spatial information indicating the space, and an output means for outputting an image representing a trajectory of the target in the space and a text generated by the text generation means.

An information processing apparatus according to an example aspect of the present disclosure includes a target detection means for detecting a target existing in a space using sensor information, a target tracking means for tracking a target detected by the target detection means, a label assigning means for assigning a label indicating an importance to a trajectory of the target obtained by tracking by the target tracking means, and a training means for training a learning model using training data including a trajectory labeled by the label assigning means and environmental information regarding an environment of the target as inputs and an importance of the trajectory as an output.

An information processing method according to an example aspect of the present disclosure includes target detection processing of detecting, by at least one processor, a target existing in a space using sensor information indicating a sensing result by a sensor that senses the space, target tracking processing of tracking, by the at least one processor, a target detected in the target detection processing, text generation processing of generating, by the at least one processor, a text describing a trajectory of the target using a tracking result by the target tracking processing, environmental information regarding an environment of the target, and spatial information indicating the space, and output processing of outputting, by the at least one processor, an image representing a trajectory of the target in the space and a text generated in the text generation processing.

An information processing program according to an example aspect of the present disclosure is an information processing program for causing a computer to function as an information processing apparatus, the program causing the computer to function as a target detection means for detecting a target existing in a space using sensor information indicating a sensing result by a sensor configured to sense the space, a target tracking means for tracking a target detected by the target detection means, a text generation means for generating a text describing a trajectory of the target using a tracking result by the target tracking means, environmental information regarding an environment of the target, and spatial information indicating the space, and an output means for outputting an image representing a trajectory of the target in the space and a text generated by the text generation means.

An information processing method according to an example aspect of the present disclosure includes target detection processing of detecting, by at least one processor, a target existing in a space using sensor information, target tracking processing of tracking, by the at least one processor, the target detected in the target detection processing, label assigning processing of assigning, by the at least one processor, a label indicating the importance to the trajectory of the target obtained by tracking in the target tracking processing, and training processing of training, by the at least one processor, a learning model in which the trajectory and the environmental information are input and the importance of the trajectory is output using the training data including the trajectory labeled by the label assigning processing and the environmental information regarding the environment of the target.

An information processing program according to an example aspect of the present disclosure is an information processing program for causing a computer to function as an information processing apparatus, the program causing the computer to function as a target detection means for detecting a target existing in a space using sensor information, a target tracking means for tracking a target detected by the target detection means, a label assigning means for assigning a label indicating an importance to a trajectory of the target obtained by tracking by the target tracking means, and a training means for training a learning model using training data including a trajectory labeled by the label assigning means and environmental information regarding an environment of the target as inputs and an importance of the trajectory as an output.

According to an example aspect of the present disclosure, it is possible to provide a technique that facilitates determination of a trajectory of a target by a user.

### BRIEF DESCRIPTION OF DRAWINGS

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of an information processing apparatus according to the present disclosure;

FIG. 4 is a flowchart illustrating a flow of an information processing method according to the present disclosure;

FIG. 5 is a block diagram illustrating a configuration of an information processing apparatus according to the present disclosure;

FIG. 6 is a block diagram illustrating a functional configuration of an information processing apparatus according to the present disclosure;

FIG. 7 is a diagram illustrating a specific example of an image output by an image output unit and a text output by a text output unit according to the present disclosure;

FIG. 8 is a block diagram illustrating a configuration of a computer functioning as the information processing apparatus according to the present disclosure; and

FIG. 9 is a diagram illustrating an example of an image representing a trajectory according to a conventional technique.

### EXAMPLE EMBODIMENT

Hereinafter, example embodiments of the present invention will be described. However, the present invention is not limited to the following illustrative example embodiments, and various modifications can be made within a scope described in the claims. For example, example embodiments obtained by appropriately combining technologies (some or all of things or methods) adopted in the following illustrative example embodiments can also be included in the scope of the present invention. Example embodiments obtained by appropriately omitting some of the technologies adopted in the following illustrative example embodiments can also be included in the scope of the present invention. Effects mentioned in the following illustrative example embodiments are examples of effects expected in the illustrative example embodiments, and do not define extension of the present invention. That is, example embodiments that do not achieve the effects mentioned in the following illustrative example embodiments can also be included in the scope of the present invention.

### First Illustrative Example Embodiment

A first illustrative example embodiment that is an example of the example embodiments of the present invention will be described in detail with reference to the drawings. The present illustrative example embodiment is a basic form of each illustrative example embodiment to be described below. An application range of each technology adopted in the present illustrative example embodiment is not limited to the present illustrative example embodiment. In other words, each technology adopted in the present illustrative example embodiment can also be adopted in another illustrative example embodiment included in the present disclosure within a range in which no particular technical problem occurs. Each technique illustrated in the drawings referred to for description of the present illustrative example embodiment can also be adopted in the other illustrative example embodiments included in the present disclosure within a range in which no particular technical problem occurs.

### (Configuration of Information Processing Apparatus)

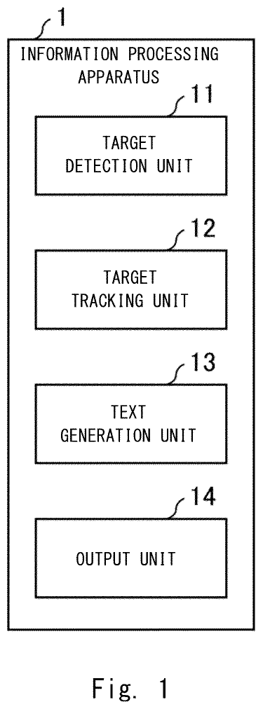

A configuration of an information processing apparatus 1 will be described with reference to FIG. 1. FIG. 1 is a block diagram illustrating a configuration of the information processing apparatus 1. As illustrated in FIG. 1, the information processing apparatus 1 includes a target detection unit 11, a target tracking unit 12, a text generation unit 13, and an output unit 14. The target detection unit 11 detects a target existing in a space using sensor information indicating a sensing result by a sensor that senses the space. The target tracking unit 12 tracks the target detected by the target detection unit 11. The text generation unit 13 generates a text describing the trajectory of the target using the tracking result by the target tracking unit 12, the environmental information regarding an environment of the target, and the spatial information indicating the space. The output unit 14 outputs an image representing the trajectory of the target in the space and the text generated by the text generation unit 13.

### (Effects of Information Processing Apparatus)

As described above, the information processing apparatus 1 employs a configuration including the target detection unit 11 that detects a target existing in a space using sensor information indicating a sensing result by a sensor that senses the space, the target tracking unit 12 that tracks the target detected by the target detection unit 11, the text generation unit 13 that generates a text describing a trajectory of the target using a tracking result by the target tracking unit 12, environmental information regarding an environment of the target, and spatial information indicating the space, and the output unit 14 that outputs an image representing a trajectory of the target in the space and the text generated by the text generation unit 13. Therefore, according to the information processing apparatus 1, it is possible to easily determine the trajectory of the target by the user.

### (Flow of Information Processing Method)

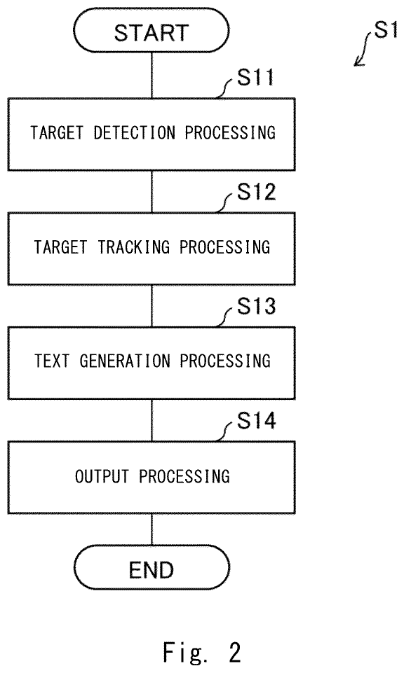

A flow of an information processing method S1 will be described with reference to FIG. 2. FIG. 2 is a flowchart illustrating the flow of the information processing method S1. As illustrated in FIG. 2, the information processing method S1 includes target detection processing S11, target tracking processing S12, text generation processing S13, and output processing S14. In the target detection processing S11, at least one processor detects a target existing in a space using sensor information indicating a sensing result by a sensor that senses the space. In the target tracking processing S12, the at least one processor tracks the target detected in the target detection processing S11. In the text generation processing S13, the at least one processor generates a text describing the trajectory of the target using the tracking result by the target tracking processing S12, the environmental information regarding an environment of the target, and the spatial information representing the space. In the output processing S14, the at least one processor outputs an image representing the trajectory of the target in the space and the text generated in the text generation processing S13.

### (Effects of Information Processing Method)

As described above, the information processing method S1 adopts a configuration including the target detection processing S11 of detecting, by at least one processor, a target existing in a space using sensor information indicating a sensing result by a sensor that senses the space, the target tracking processing S12 of tracking, by the at least one processor, the target detected in the target detection processing S11, the text generation processing S13 of generating, by the at least one processor, a text describing a trajectory of the target using a tracking result by the target tracking processing S12, environmental information regarding an environment of the target, and spatial information representing the space, and the output processing S14 of outputting, by the at least one processor, an image representing the trajectory of the target in the space and the text generated in the text generation processing S13. Therefore, according to the information processing method S1, it is possible to easily determine the trajectory of the target by the user.

### (Configuration of Information Processing Apparatus)

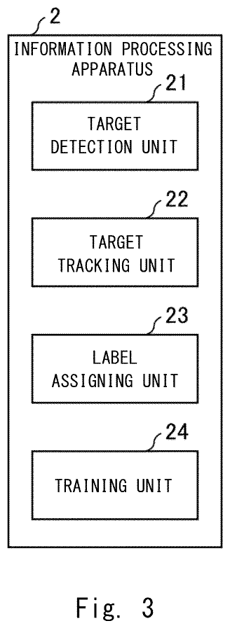

A configuration of an information processing apparatus 2 will be described with reference to FIG. 3. FIG. 3 is a block diagram illustrating the configuration of the information processing apparatus 2. As illustrated in FIG. 3, the information processing apparatus 2 includes a target detection unit 21, a target tracking unit 22, a label assigning unit 23, and a training unit 24. The target detection unit 21 detects a target existing in the space using the sensor information. The target tracking unit 22 tracks the target detected by the target detection unit 21. The label assigning unit 23 labels the trajectory of the target obtained by tracking by the target tracking unit 22 with a label indicating the importance. The training unit 24 trains the learning model in which the trajectory and the environmental information are input and the importance of the trajectory is output using the training data including the trajectory labeled by the label assigning unit 23 and the environmental information regarding an environment of the target.

### (Effects of Information Processing Apparatus)

As described above, the information processing apparatus 2 employs a configuration including the target detection unit 21 that detects a target existing in a space using sensor information, the target tracking unit 22 that tracks the target detected by the target detection unit 21, the label assigning unit 23 that assigns a label indicating the importance to a trajectory of the target obtained by tracking by the target tracking unit 22, and the training unit 24 that trains a learning model using training data including the trajectory and environmental information as inputs and outputting the importance of the trajectory, the trajectory being labeled by the label assigning unit 23, and environmental information regarding an environment of the target. Therefore, according to the information processing apparatus 2, it is possible to generate a learning model which facilitates determination on the trajectory of the target by the user.

### (Flow of Information Processing Method)

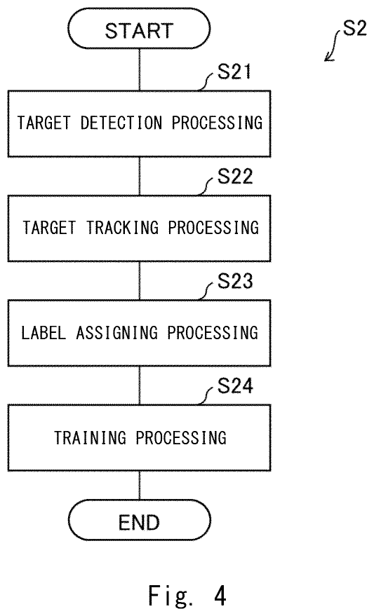

A flow of an information processing method S2 will be described with reference to FIG. 2. FIG. 4 is a flowchart illustrating the flow of the information processing method S2. As illustrated in FIG. 4, the information processing method S2 includes target detection processing S21, target tracking processing S22, label assigning processing S23, and training processing S24.

In the target detection processing S21, at least one processor detects a target existing in a space using the sensor information. In the target tracking processing S22, the at least one processor tracks the target detected in the target detection processing S21. In the label assigning processing S23, the at least one processor assigns a label indicating the importance to the target trajectory obtained by tracking in the target tracking processing S22. The at least one processor trains the learning model in which the trajectory and the environmental information are input and the importance of the trajectory is output using the training data including the trajectory labeled by the label assigning processing S23 and the environmental information regarding an environment of the target.

### (Effects of Information Processing Method)

As described above, the information processing method S2 adopts a configuration including the target detection processing S21 of detecting, by at least one processor, a target existing in a space using sensor information, the target tracking processing S22 of tracking, by the at least one processor, the target detected in the target detection processing S21, the label assigning processing S23 of assigning, by the at least one processor, a label indicating the importance to the trajectory of the target obtained by tracking in the target tracking processing S22, and the training processing S24 of training, by the at least one processor, a learning model in which the trajectory and the environmental information are input and the importance of the trajectory is output using the training data including the trajectory labeled by the label assigning processing S23 and the environmental information regarding the environment of the target. Therefore, according to the information processing method S2, it is possible to generate a learning model which facilitates determination on the trajectory of the target by the user.

### Second Illustrative Example Embodiment

A second illustrative example embodiment that is an example of the example embodiments of the present invention will be described in detail with reference to the drawings. Components that have the same functions as the components described in the above-described illustrative example embodiment are denoted by the same reference signs, and description of the components will be appropriately omitted. An application range of each technology adopted in the present illustrative example embodiment is not limited to the present illustrative example embodiment. In other words, each technology adopted in the present illustrative example embodiment can also be adopted in another illustrative example embodiment included in the present disclosure within a range in which no particular technical problem occurs. Each technique illustrated in each of the drawings referred to for describing the present illustrative example embodiment can be employed in the other illustrative example embodiments included in the present disclosure within the scope in which no particular technical problem occurs.

### (Configuration of Information Processing Apparatus)

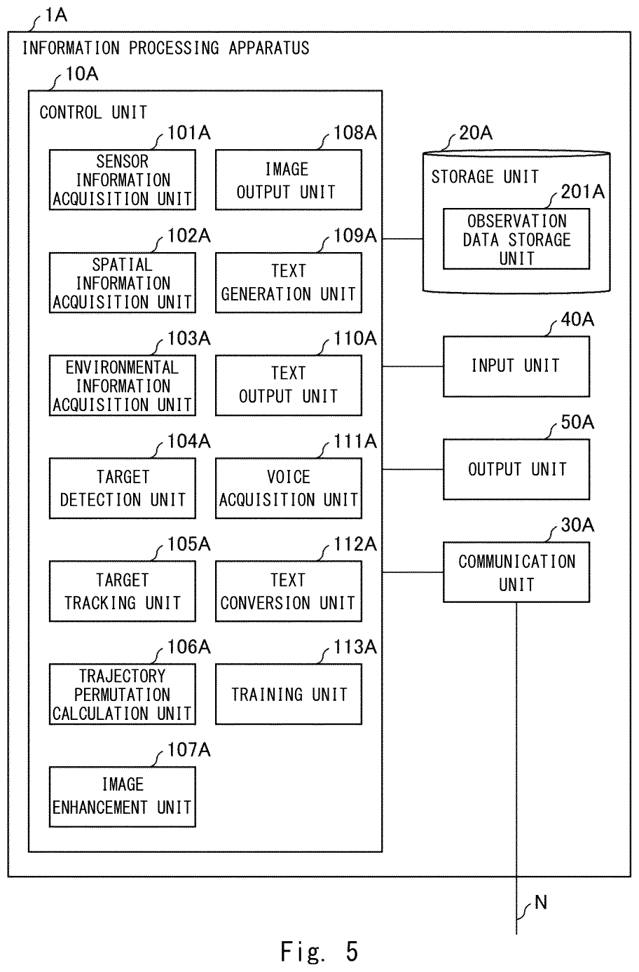

FIG. 5 is a block diagram illustrating a configuration of an information processing apparatus 1A according to the present disclosure. The information processing apparatus 1A is an apparatus that tracks a target and presents a trajectory of movement of the target to a user. Here, examples of the target include an aircraft, a ship, a drone, an automobile, a robot, a person, and an animal. However, the target is not limited to these. The information processing apparatus 1A enhances and presents an important trajectory among the plurality of trajectories to the user, and presents information relevant to the important trajectory to the user by text. Examples of the text relevant to the trajectory include reports in work and instructions related to work of an aircraft control tower, reports in security work and instructions related to work of commercial facilities, hospitals, and the like. More specifically, the text relevant to the trajectory may include, for example, text describing how the aircraft has moved and text indicating a prediction result for how the aircraft will move. The user makes a decision about the target's trajectory (performing a warning, performing rescue, or the like) by checking the presented information.

As illustrated in FIG. 5, the information processing apparatus 1A includes a control unit 10A, a storage unit 20A, a communication unit 30A, an input unit 40A, and an output unit 50A. The communication unit 30A communicates with a device outside the information processing apparatus 1A via a communication line N. The communication unit 30A transmits data supplied from the control unit 10A to another device, and supplies data received from another device to the control unit 10A.

### (Input Unit/Output Unit)

The input unit 40A is a configuration for receiving an input to the information processing apparatus 1A, and includes, as an example, an input device such as a keyboard, a mouse, a touch panel, a camera, or a microphone. The input unit 40A may be configured to receive data from the input device via, for example, an interface such as a universal serial bus (USB). The output unit 50A is a configuration for performing output from the information processing apparatus 1A, and includes, as an example, an output device such as a display, a printer, a touch panel, or a speaker. The output unit 50A may include, for example, an interface such as a USB, and may be configured to output data to the output device via the interface.

### (Storage Unit)

The storage unit 20A stores various types of information to be referred to by the control unit 10A. The storage unit 20A particularly includes an observation data storage unit 201A. The observation data storage unit 201A stores observation data including a trajectory of a target observed in the past and environmental information when the trajectory is observed. In other words, it can also be said that the observation data storage unit 201A stores the trajectory of the target observed in the past and the environmental information in association with each other. The observation data storage unit 201A stores ground truth data generated by a ground truth data generation unit 115A to be described later in association with a trajectory of a target observed in the past and environmental information. The ground truth data is data indicating which trajectory is important and which trajectory is not important. The data stored in the observation data storage unit 201A is used for training of a learning model used by a trajectory permutation calculation unit 106A to be described later for calculating the importance. In other words, it can also be said that the observation data storage unit 201A stores training data including a plurality of sets of a past tracking result, environmental information relevant to the tracking result, and the ground truth data generated by the ground truth data generation unit 115A to be described later.

### (Control Unit)

The control unit 10A includes a sensor information acquisition unit 101A, a spatial information acquisition unit 102A, an environmental information acquisition unit 103A, a target detection unit 104A, a target tracking unit 105A, a trajectory permutation calculation unit 106A, an image enhancement unit 107A, an image output unit 108A, a text generation unit 109A, a text output unit 110A, a voice acquisition unit 111A, a text conversion unit 112A, and a training unit 113A. The target detection unit 104A, the target tracking unit 105A, the trajectory permutation calculation unit 106A, the image enhancement unit 107A, and the text generation unit 109A are examples of a target detection means, a target tracking means, an importance calculation means, a selection means, and a text generation means according to the present disclosure. The image output unit 108A and the text output unit 110A are examples of output means according to the present disclosure. The training unit 113A is an example of a label assigning means and a training means according to the present disclosure.

### (Sensor Information Acquisition Unit)

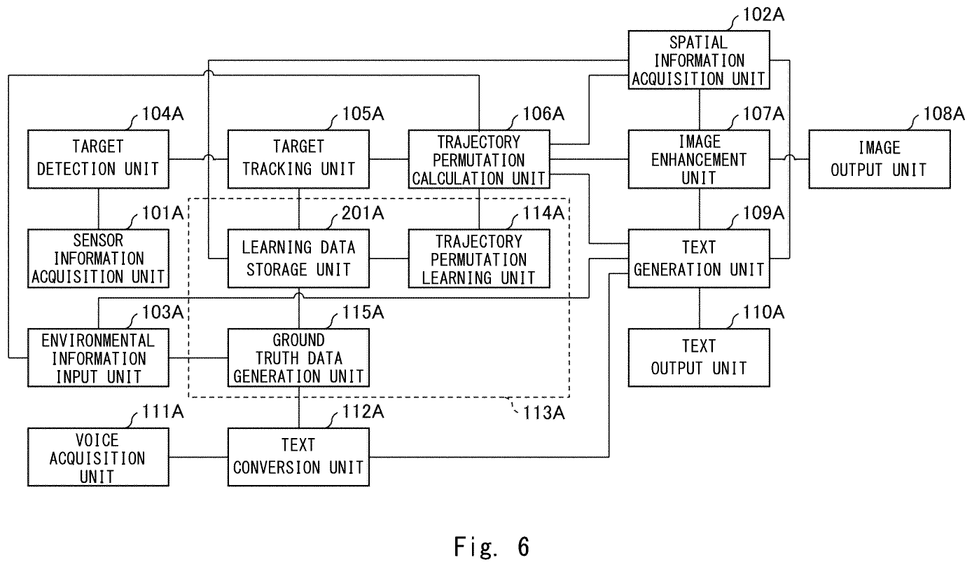

FIG. 6 is a block diagram illustrating an example of a functional configuration of the information processing apparatus 1A. The sensor information acquisition unit 101A acquires sensor information indicating a sensing result by a sensor that senses a space. Here, examples of the sensor that senses the space include radar, laser imaging detection and ranging (LIDAR), an event camera, an infrared camera, a monitoring camera, and an in-vehicle camera. Examples of the sensor information include information indicating a measurement result by radar or LIDAR, and image data (multispectral image, SAR (Synthetic Aperture Radar) image, infrared image, monitoring image, in-vehicle image, and the like).

As an example, the sensor information acquisition unit 101A acquires sensor information input to the input unit 40A. The sensor information acquisition unit 101A may receive sensor information from another device via the communication unit 30A. The sensor information acquisition unit 101A may acquire sensor information by reading the sensor information from a storage destination (a storage device in the information processing apparatus 1A or a storage device outside the information processing apparatus 1A may be used) designated by the user of the information processing apparatus 1A. The sensor information acquisition unit 101A may perform preprocessing such as noise removal processing on the sensor information.

### (Spatial Information Acquisition Unit)

The spatial information acquisition unit 102A acquires spatial information indicating spatial information. The spatial information is, for example, data representing a map, a satellite image, and an aerial image of a target region. The spatial information may include information indicating the geography of the space (for example, information indicating latitude and longitude). As an example, the spatial information acquisition unit 102A acquires the spatial information input to the input unit 40A. The spatial information acquisition unit 102A may receive spatial information from another device via the communication unit 30A. The spatial information acquisition unit 102A may acquire spatial information by reading the spatial information from a storage destination (a storage device in the information processing apparatus 1A or a storage device outside the information processing apparatus 1A may be used) designated by the user of the information processing apparatus 1A.

### (Environmental Information Acquisition Unit)

The environmental information acquisition unit 103A acquires environmental information regarding the environment of a target. Examples of the environmental information include temperature, climate, topical information (external news such as an aircraft departing xx airport, etc.), observation information at another point (sensor information at another point, etc.), and date and time at which the sensor information is acquired. Examples of the observation information of another point include satellite data of another point and information indicating the weather of the surrounding environment. As an example, the environmental information is used by the text generation unit 109A to be described later to generate a text.

As an example, the environmental information acquisition unit 103A acquires the environmental information input to the input unit 40A. The environmental information acquisition unit 103A may receive environmental information from another device via the communication unit 30A. The environmental information acquisition unit 103A may acquire environmental information by reading the environmental information from a storage destination (a storage device in the information processing apparatus 1A or a storage device outside the information processing apparatus 1A may be used) designated by the user of the information processing apparatus 1A.

### (Target Detection Unit)

The target detection unit 104A detects a target existing in the space using the sensor information acquired by the sensor information acquisition unit 101A, and generates data indicating a detection result. The data generated by the target detection unit 104A is, for example, coordinate data indicating a target area with a rectangle. As an example, in a case where the sensor information is information indicating a measurement result by radar or LIDAR, the target detection unit 104A detects a target based on the measurement result by radar or LIDAR. In a case where the sensor information is image data (multispectral image, infrared image, etc.), the target detection unit 104A detects a target by a method using an object detection model such as YOLOX as an example. The method using the object detection model is not limited to YOLOX, and the target detection unit 104A may detect the target using other methods such as You Only Look Once (YOLO), a Vision Transformer (ViT), Regions with CNN features (Faster R-CNN), and a Single Shot MultiBox Detector (SSD).

### (Target Tracking Unit)

The target tracking unit 105A tracks a target detected by the target detection unit 104A by correlating the target in time series, and generates data indicating a tracking result. The data indicating the tracking result is, for example, time-series coordinates indicating each of the trajectories obtained by tracking by the target tracking unit 105A. As an example, in a case where the sensor information is information indicating a measurement result by radar or LIDAR, the target tracking unit 105A tracks the target by a method using a Kalman filter or the like. In a case where the sensor information is image data, the target tracking unit 105A tracks the target by a ByteTrack method as an example.

### (Trajectory Permutation Calculation Unit)

The trajectory permutation calculation unit 106A calculates the importance of each trajectory for each of the plurality of trajectories obtained by tracking by the target tracking unit 105A, and prioritizes the trajectories in descending order of the importance. The importance calculated by the trajectory permutation calculation unit is, for example, a vector in which the number of trajectories is the number of dimensions and the importance of each trajectory is each component.

As an example, the trajectory permutation calculation unit 106A calculates the importance using a learning model generated by machine learning. Examples of the learning model include a deep neural network. More specifically, examples of the deep neural network using the time-series data as an input include a long short-term memory (LSTM) and a one-dimensional convolutional neural network (1D CNN). As an example, the learning model is trained by a trajectory permutation learning unit 114A to be described later.

The input data input to the learning model includes data indicating the tracking result obtained by the target tracking unit 105A. The input data may include at least one of environmental information and spatial information in addition to the data indicating the tracking result. In other words, the learning model can be said to be a learning model in which the trajectory, the environmental information, and the spatial information are input and the importance of the target trajectory is output.

### (Image Enhancement Unit)

The image enhancement unit 107A selects the trajectory having the higher importance than the other targets from among the plurality of trajectories obtained by the tracking by the target tracking unit 105A. As an example, the image enhancement unit 107A selects a trajectory having a priority higher than a predetermined threshold. The image enhancement unit 107A generates a superimposed image in which an image representing a trajectory is superimposed on the image represented by the spatial information acquired by the spatial information acquisition unit 102A.

As an example, the image enhancement unit 107A generates a superimposed image in which an image representing the selected trajectory is superimposed on an image represented by the spatial information. In this case, it can also be said that the superimposed image is an image on which an important orbit is superimposed on a map or a satellite image.

As another example, the image enhancement unit 107A may generate, for example, an image in which the selected trajectory is enhanced more than other trajectories as a superimposed image. As a method of enhancing the selected trajectory, for example, the image enhancement unit 107A may make the color of the trajectory with high priority different from the color of other trajectories, or may make the thickness of the trajectory with high priority thicker than other trajectories. The image enhancement unit 107A may enhance the selected trajectory by making the type of line drawing a trajectory with a high priority different from the types of lines of other trajectories.

The image enhancement unit 107A may superimpose the predicted future trajectory on the image indicating the space in addition to the trajectory obtained by the tracking by the target tracking unit 105A. In this case, as an example, the image enhancement unit 107A may select one or a plurality of trajectories similar to the trajectory obtained by tracking by the target tracking unit 105A from the observation data accumulated in the past (set of data indicating which trajectory is important and which trajectory is not important), and superimpose the selected trajectory on an image indicating a space as a predicted trajectory.

### (Image Output Unit)

The image output unit 108A outputs the image data generated by the image enhancement unit 107A. As an example, the image output unit 108A outputs image data to a display connected to the output unit 50A, and causes the display to display an image represented by the image data. The image output unit 108A may transmit the image data to another device connected via the communication unit 30A, and cause a display of the another device to display an image represented by the image data.

The image output unit 108A may also write and output the image data to a storage destination (a storage device in the information processing apparatus 1A or a storage device outside the information processing apparatus 1A may be used) designated by the user of the information processing apparatus 1A. The image output unit 108A may output the data to an output device such as a speaker or a printer.

### (Text Generation Unit)

The text generation unit 109A generates a text describing the target trajectory using the environmental information and the spatial information. The text generation unit 109A may generate a text using the trajectory obtained by the target tracking unit 105A in addition to the environmental information and the spatial information. In this case, the text generation unit 109A may generate a text describing the trajectory using the trajectory selected by the image enhancement unit 107A among the plurality of trajectories, the environmental information, and the spatial information.

As an example, the text generation unit 109A generates a text using a large-scale language model. Examples of the large-scale language model include, but are not limited to, generative AI such as ChatGPT (Chat Generative Pre-trained Transformer), GPT-4 (Generative Pre-trained Transformer 4), or GPT-40, or generative AI finely tuned using environmental information, spatial information, or the like.

The large-scale language model may be stored in the storage unit 20A of the information processing apparatus 1A or may be stored in a device other than the information processing apparatus 1A. Here, the large-scale language model being stored in the storage device (the storage unit 20A or the like) means that a parameter that defines the large-scale language model is stored in the storage device. In a case where the large-scale language model is stored in a device other than the information processing apparatus 1A, for example, the text generation unit 109A transmits input data to the device via the communication unit 30A, receives output data transmitted from the device, and generates the text based on the received output data.

### (Input to Large-Scale Language Model)

The input data input to the large-scale language model includes environmental information and spatial information. The input data may include a tracking result by the target tracking unit 105A. In other words, the text generation unit 109A can generate the text describing the trajectory of the target based on the output data obtained by inputting the input data including the tracking result, the environmental information, and the spatial information to the large-scale language model.

The input data may include text converted by the text conversion unit 112A described later. In this case, the text generation unit 109A generates a text describing the trajectory using the text converted by the text conversion unit 112A in addition to the tracking result, the environmental information, and the spatial information. In other words, in addition to the tracking result, the environmental information, and the spatial information, the text generation unit 109A can also be said to generate a text describing the trajectory of the target using a text representing the utterance voice of the user.

The input data may include the superimposed image generated by the image enhancement unit 107A. In this case, it can also be said that the text generation unit 109A generates a text describing the trajectory using the image output by the image output unit 108A in addition to the tracking result, the environmental information, and the spatial information.

The input data may include an instruction sentence. The instruction sentence is, for example, a text such as “The following shows the image on which the tracking target is superimposed, the date, the trajectory of the tracking target, the importance of the trajectory, and the environmental information (temperature, etc.). Please summarize them with reference to the past answer text”. The input data may include the importance calculated by the trajectory permutation calculation unit 106A in addition to the above data.

The input data may include environmental information relevant to the past trajectory similar to the tracking result by the target tracking unit 105A. In this case, the text generation unit 109A searches for one or a plurality of trajectories similar to the target trajectory tracked by the target tracking unit 105A from the observation data storage unit 201A, and includes the environmental information stored in association with the searched trajectory in the input data of the large-scale language model.

The input data may also include answer text obtained in the past for similar trajectories. In this case, the text generation unit 109A stores the answer text, obtained by inputting the trajectory and the environmental information of the target observed in the past to the large-scale language model, in the observation data storage unit 201A in association with the trajectory of the target observed in the past and the environmental information relevant to the trajectory, and includes the past answer text stored in association with the searched trajectory in the input data of the large-scale language model.

### (Output of Large-Scale Language Model)

The output of the large-scale language model includes the answer text. The answer text is, for example, a text such as “At yy:zz on the xx-th, bb (target object) passed near point aa in a state of cc (speed, etc.). There is a possibility that it will pass dd in the future. As a similar case in the past, it passed kk point and mm point at hh:jj on ff gg, ee. At that time, it was determined that nn (for example, action such as rescue)”. The output of the large-scale language model may include data other than text (image data, voice data, and the like).

### (Pre-training of Large-Scale Language Model)

The text generation unit 109A may train the large-scale language model in advance by fine tuning, instruction tuning, or the like so that the large-scale language model outputs a more desirable text. In this case, as an example, the training data used for fine tuning, instruction tuning, and the like includes at least one of the text converted by the text conversion unit 112A, the spatial information acquired by the spatial information acquisition unit 102A, the environmental information acquired by the environmental information acquisition unit 103A, the superimposed image generated by the image enhancement unit 107A, the trajectory obtained by the target tracking unit 105A, and the importance calculated by the trajectory permutation calculation unit 106A for the past case.

The training data includes answer text (answer text output by the large-scale language model in the past) relevant to the past trajectory. The answer text relevant to the past trajectory is an answer text (instructions related to reports and work, and the like) relevant to a similar trajectory. The training data may include similar environmental information relevant to a trajectory predicted from past similar data. Here, the similar environmental information is environmental information relevant to data having similar trajectories (the number of trajectories, similar movements, passing through the same point, and the like) among observation data observed in the past.

### (Text Output Unit)

The text output unit 110A outputs the text generated by the text generation unit 109A. As an example, the text output unit 110A outputs the text to a display connected to the output unit 50A, and causes the display to display the text. The text output unit 110A may transmit the text to another device connected via the communication unit 30A and cause a display of the another device to display the text.

The text output unit 110A may also write and output the text to a storage destination (a storage device in the information processing apparatus 1A or a storage device outside the information processing apparatus 1A may be used) designated by the user of the information processing apparatus 1A. The text output unit 110A may output the text to an output device such as a speaker or a printer.

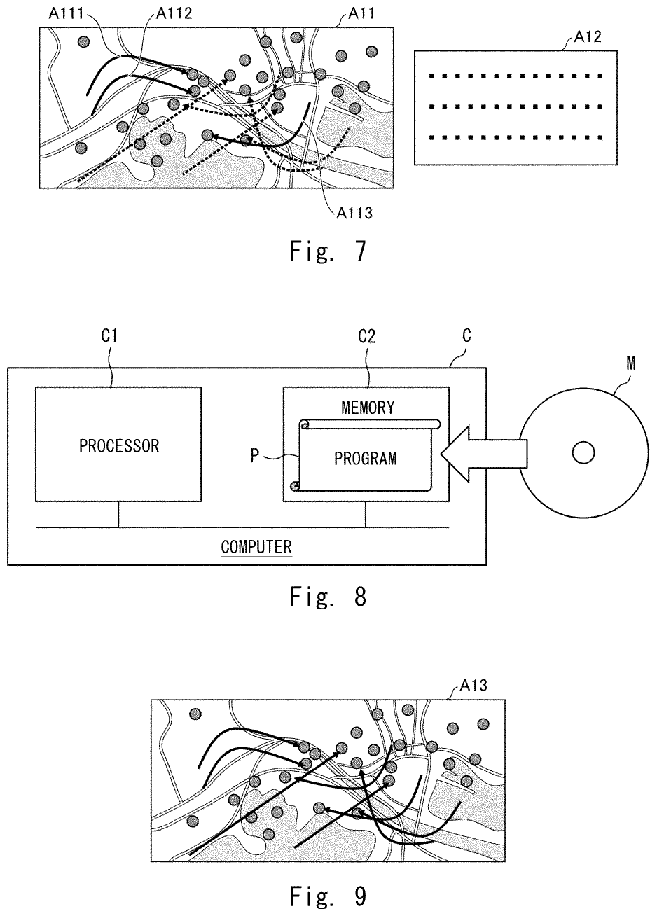

FIG. 7 is a diagram illustrating a specific example of the image output by the image output unit 108A and the text output by the text output unit 110A. As illustrated in FIG. 7, the image output unit 108A and the text output unit 110A output an image A11 representing the trajectory of the target in the space and a text A12 describing the trajectory of the target. In FIG. 7, the image A11 is an image in which trajectories A111 to A113 selected by the image enhancement unit 107A are enhanced more than other trajectories. FIG. 9 is a diagram illustrating an example of an image representing a trajectory according to a conventional technique. In the example of FIG. 9, the image A13 including a plurality of trajectories is displayed. An unimportant trajectory and an important trajectory are mixed in the image A13, and even if the user confirms the image A13, it is difficult for the user to determine which trajectory is important and whether a trajectory requiring some measures is included. As is clear from a comparison between the image A13 of FIG. 9 and the image A11 of FIG. 7, according to the image output by the information processing apparatus 1A according to the present disclosure, it is possible to facilitate the user to grasp an important trajectory.

### (Voice Acquisition Unit/Text Conversion Unit)

The voice acquisition unit 111A acquires voice data representing the utterance voice of the user. As an example, the voice data is data in which a voice uttered when the user discriminates which trajectory is an important trajectory is recorded by a microphone recorder or the like. As an example, the voice data is used for the purpose of reducing loss of visual confirmation work. Further, the voice data may be used for recording visual confirmation work. The text conversion unit 112A converts the voice data into a text. As an example, the text conversion unit 112A performs conversion processing using a voice conversion method using deep learning.

### (Training Unit/Ground Truth Data Generation Unit)

The training unit 113A trains the regression function of the trajectory permutation calculation unit 106A. The training unit 113A includes a trajectory permutation learning unit 114A and a ground truth data generation unit 115A. The ground truth data generation unit 115A assigns a label (ground truth data) indicating the importance to the trajectory of the target obtained by tracking by the target tracking unit 105A.

As an example, the ground truth data generation unit 115A extracts a word/phrase relevant to an important trajectory from the text representing the utterance voice of the user, selects a trajectory relevant to the extracted word/phrase from among a plurality of trajectories obtained by tracking by the target tracking unit 105A, and assigns a label indicating the importance to the selected trajectory. In this case, for example, the administrator or the like of the information processing apparatus 1A performs an operation of selecting an important word/phrase from the text representing the utterance voice using the input device connected to the input unit 40A. The ground truth data generation unit 115A extracts the selected word/phrase as an important word/phrase, and assigns a label indicating a high importance to a trajectory relevant to the extracted word/phrase. Here, examples of the trajectory relevant to the extracted word/phrase include, but are not limited to, a trajectory of an object passing through a region indicated by the extracted word/phrase or a trajectory of an object passing through a predetermined region at a date and time indicated by the extracted word/phrase.

As another example, the ground truth data generation unit 115A may present the environmental information and the text to the administrator or the like, and the administrator or the like may confirm the presented environmental information and text and extract a word/phrase relevant to an important trajectory. In this case, the ground truth data generation unit 115A may generate the ground truth data by giving an importance to the trajectory relevant to the word/phrase extracted by the administrator or the like.

As another example, the ground truth data generation unit 115A may generate the ground truth data by extracting a word/phrase relevant to an important trajectory from the environmental information and the text information using a learning model such as a large-scale language model and giving an importance to the trajectory relevant to the word/phrase.

### (Trajectory Permutation Learning Unit)

The trajectory permutation learning unit 114A trains the learning model using the training data indicating the labeled trajectory. The training data may include environmental information and spatial information in addition to the data indicating the labeled trajectory. In other words, in this case, it can be said that the trajectory permutation learning unit 114A trains the learning model using training data including the trajectory to which the label is given, the environmental information, and the spatial information. The weight optimized by the trajectory permutation learning unit 114A is, for example, a regression function using a deep neural network. More specifically, such weight of the deep neural network using the time-series data as an input includes a weight of an LSTM or a one-dimensional convolutional neural network (1DCNN). These weights are calculated, for example, based on training data. More specifically, for example, a loss function based on a difference between the importance (estimated importance) regressed using the tracking result, the environmental information, and the spatial information as input variables and the ground truth importance, and the trajectory permutation learning unit 114A learns the weight so as to minimize the loss function.

### Application Example

The information processing apparatus 1A according to the present disclosure is applicable to various technical fields such as robotics, logistics systems, and drone control. For example, in the case of robotics, the target according to the present disclosure is, as an example, a robot that moves an object, and the text generated by the text generation unit 109A is, as an example, a report that explains work content by the robot or an instruction regarding work. For example, in the case of a logistics system, a target according to the present disclosure is, as an example, a delivery person who delivers a product, and a text generated by the text generation unit 109A is, as an example, a work report regarding a delivery work using a delivery vehicle or an instruction regarding the work.

### (Effects of Information Processing Apparatus)

As described above, the information processing apparatus 1A adopts a configuration including the trajectory permutation calculation unit 106A that calculates the importance of each trajectory for each of a plurality of trajectories obtained by tracking by the target tracking unit 105A, and the image enhancement unit 107A that selects a trajectory having the importance higher than other targets from among the plurality of trajectories, in which the text generation unit 109A generates a text describing the trajectory using the trajectory selected by the image enhancement unit 107A, the environmental information, and the spatial information, and the image output unit 108A and the text output unit 110A output an image in which the trajectory selected by the image enhancement unit 107A is enhanced more than other trajectories and a text generated by the text generation unit 109A. Therefore, according to the information processing apparatus 1A, even in a case where orbits of a plurality of targets are included in the monitoring area, the user can easily grasp what kind of feature the orbit to be gazed has. As a result, according to the information processing apparatus 1A, it is possible to support the user in making a decision about the trajectory of the target.

The information processing apparatus 1A adopts a configuration in which the text generation unit 109A generates a text describing a trajectory of the target using a text representing an utterance voice of the user in addition to the tracking result, the environmental information, and the spatial information. Therefore, according to the information processing apparatus 1A, it is possible to obtain an effect that the text describing the trajectory of the target can be generated more accurately.

The information processing apparatus 1A employs a configuration in which the text generation unit 109A generates a text describing a trajectory of a target based on output data obtained by inputting input data including the tracking result, the environmental information, and the spatial information to a large-scale language model. Therefore, according to the information processing apparatus 1A, it is possible to output a text for making it easy for the user to determine the trajectory of the target.

The information processing apparatus 1A employs a configuration in which the text generation unit 109A searches for a trajectory similar to the trajectory of the target tracked by the target tracking unit 105A from the observation data storage unit 201A that stores the trajectory of the target observed in the past and the environmental information in association with each other, and includes the environmental information relevant to the searched trajectory in the input data. Therefore, according to the information processing apparatus 1A, it is possible to generate a text in which a trajectory observed in the past is taken into consideration, and thus, it is possible to generate a text with higher accuracy.

The information processing apparatus 1A employs a configuration in which the text generation unit 109A stores an answer text, obtained by inputting a trajectory of a target observed in the past and environmental information into a large-scale language model, in the observation data storage unit 201A in association with the trajectory of the target observed in the past and the environmental information relevant to the trajectory, and includes the past answer text stored in association with the searched trajectory in the input data. Therefore, according to the information processing apparatus 1A, it is possible to generate the text (for example, instructions related to reports and work) in which the answer of the trajectory observed in the past is considered, and thus, it is possible to generate the text (for example, a text according to a format of a report generated in the past or an instruction regarding work) desired by the user.

The information processing apparatus 1A employs a configuration including the ground truth data generation unit 115A that assigns a label indicating an importance to a target trajectory obtained by tracking by the target tracking unit 105A, and the trajectory permutation learning unit 114A that trains a learning model using training data including a trajectory to which the label is assigned and environmental information, the learning model having the trajectory and the environmental information as inputs, and the importance of the target trajectory as an output, in which the trajectory permutation calculation unit 106A calculates the importance using the learning model. Therefore, according to the information processing apparatus 1A, the importance of the trajectory can be calculated more accurately.

### [Implementation Example by Software]

Some or all of the functions of the information processing apparatuses 1, 1A, and 2 (hereinafter, also referred to as “each of the above apparatuses”) may be implemented by hardware such as an integrated circuit (an IC chip) or may be implemented by software. In the latter case, each of the above apparatuses is achieved by, for example, a computer that executes a command of a program as software for achieving each function. An example of such a computer (hereinafter, referred to as a computer C) is illustrated in FIG. 8. FIG. 8 is a block diagram illustrating a hardware configuration of the computer C functioning as each of the above apparatuses.

The computer C includes at least one processor C1 and at least one memory C2. A program P causing the computer C to operate as each of the above apparatuses is recorded in the memory C2. In the computer C, by the processor C1 reading the program P from the memory C2 and executing the program P, each function of each of the above apparatuses is achieved.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used. As the memory C2, for example, a flash memory, a hard disk drive (HDD), a solid state drive (SSD), or a combination of these can be used.

The computer C may further include a random access memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, or a programmable logic circuit can be used. The computer C can acquire the program P via such a recording medium M. The program P can be transmitted via a transmission medium. As such a transmission medium, for example, a communication network or a broadcast wave can be used. The computer C can also acquire the program P via such a transmission medium.

Each of the above functions of each of the above apparatuses may be achieved by a single processor provided in a single computer, may be achieved in cooperation with a plurality of processors provided in a single computer, or may be achieved in cooperation with a plurality of processors provided in a plurality of computers. The program for causing each of the above apparatuses to achieve each of the above functions may be stored in a single memory provided in a single computer, may be stored in a distributed manner in a plurality of memories provided in a single computer, or may be stored in a distributed manner in a plurality of memories provided in a plurality of computers.

### [Supplementary Note A]

The present disclosure includes technologies described in the following Supplementary Notes. However, the present invention is not limited to the technologies described in the following Supplementary Notes, and various modifications can be made within the scope described in the claims.

### (Supplementary Note A1)

An information processing apparatus including:
a target detection means for detecting a target existing in a space using sensor information indicating a sensing result by a sensor configured to sense the space;
a target tracking means for tracking a target detected by the target detection means;
a text generation means for generating a text describing a trajectory of the target using a tracking result by the target tracking means, environmental information regarding an environment of the target, and spatial information indicating the space; and
an output means for outputting an image representing a trajectory of the target in the space and a text generated by the text generation means.

### (Supplementary Note A2)

The information processing apparatus according to Supplementary Note A1, further including:
an importance calculation means for calculating an importance of each of a plurality of trajectories obtained by tracking by the target tracking means; and
a selection means for selecting, from among the plurality of trajectories, a trajectory having an importance higher than that of another target, in which
the text generation means generates a text describing the trajectory using a trajectory selected by the selection means, the environmental information, and the spatial information, and
the output means outputs an image in which the trajectory selected by the selection means is enhanced more than other trajectories, and a text generated by the text generation means.

### (Supplementary Note A3)

The information processing apparatus according to Supplementary Note A1 or A2, in which the text generation means generates a text describing a trajectory of the target using a text representing an utterance voice of a user in addition to the tracking result, the environmental information, and the spatial information.

### (Supplementary Note A4)

The information processing apparatus according to any one of Supplementary Notes A1 to A3, in which the text generation means generates a text describing a trajectory of the target based on output data obtained by inputting input data including the tracking result, the environmental information, and the spatial information to a large-scale language model.

### (Supplementary Note A5)

The information processing apparatus according to Supplementary Note A4, in which the text generation means searches for a trajectory similar to a trajectory of the target tracked by the target tracking means from a storage device that stores a trajectory of a target observed in the past and environmental information in association with each other, and includes environmental information relevant to the searched trajectory in the input data.

### (Supplementary Note A6)

The information processing apparatus according to Supplementary Note A5, in which the text generation means stores an answer text, obtained by inputting a trajectory of a target observed in the past and environmental information into a large-scale language model, in the storage device in association with the trajectory of the target observed in the past and environmental information relevant to the trajectory, and a past answer text stored in association with the searched trajectory is included in the input data.

### (Supplementary Note A7)

The information processing apparatus according to Supplementary Note A2, further including:
a label assigning means for assigning a label indicating an importance to a trajectory of the target obtained by tracking by the target tracking means; and
a training means for training a learning model using training data including the labeled trajectory and the environmental information, the learning model having the trajectory and the environmental information as inputs, and an importance of the target trajectory as an output,
in which the importance calculation means calculates the importance using the learning model.

### (Supplementary Note A8)

The information processing apparatus according to Supplementary Note A7, in which the label assigning means extracts a word/phrase relevant to an important trajectory from a text representing an utterance voice of a user, selects a trajectory relevant to the extracted word/phrase from among the plurality of trajectories, and assigns a label indicating the importance to the selected trajectory.

### (Supplementary Note A9)

The information processing apparatus according to Supplementary Note A2, A7 or A8, in which the text generation means generates a text describing the trajectory using an image output by the output means in addition to the tracking result, the environmental information, and the spatial information.

### (Supplementary Note A10)

The information processing apparatus according to Supplementary Note A3, further including:
a voice acquisition means for acquiring voice data representing an utterance voice of a user; and
a text conversion means for converting the voice data into a text,
in which the text generation means generates a text describing the trajectory using a text converted by the text conversion means in addition to the tracking result, the environmental information, and the spatial information.

### (Supplementary Note A11)

An information processing apparatus including:
a target detection means for detecting a target existing in a space using sensor information;
a target tracking means for tracking a target detected by the target detection means;
a label assigning means for assigning a label indicating an importance to a trajectory of the target obtained by tracking by the target tracking means; and
a training means for training a learning model using training data including a trajectory labeled by the label assigning means and environmental information regarding an environment of the target as inputs and an importance of the trajectory as an output.

### [Supplementary Note B]

The present disclosure includes technologies described in the following Supplementary Notes. However, the present invention is not limited to the technologies described in the following Supplementary Notes, and various modifications can be made within the scope described in the claims.

### (Supplementary Note B1)

An information processing method including:
target detection processing of detecting, by at least one processor, a target existing in a space using sensor information indicating a sensing result by a sensor that senses the space;
target tracking processing of tracking, by the at least one processor, a target detected in the target detection processing;
text generation processing of generating, by the at least one processor, a text describing a trajectory of the target using a tracking result by the target tracking processing, environmental information regarding an environment of the target, and spatial information indicating the space; and
output processing of outputting, by the at least one processor, an image representing a trajectory of the target in the space and a text generated in the text generation processing.

### (Supplementary Note B2)

The information processing method according to Supplementary Note B1, further including:
importance calculation processing of calculating, by the at least one processor, an importance of each of a plurality of trajectories obtained by tracking in the target tracking processing; and
selection processing of selecting, from among the plurality of trajectories by the at least one processor, a trajectory having an importance higher than that of another target, in which
in the text generation processing, the at least one processor generates a text describing the trajectory using a trajectory selected in the selection processing, the environmental information, and the spatial information, and
in the output processing, the at least one processor outputs an image in which the trajectory selected in the selection processing is enhanced more than other trajectories, and a text generated in the text generation processing.

### (Supplementary Note B3)

The information processing method according to Supplementary Note B1 or B2, in which in the text generation processing, the at least one processor generates a text describing a trajectory of the target using a text representing an utterance voice of a user in addition to the tracking result, the environmental information, and the spatial information.

### (Supplementary Note B4)

The information processing method according to any one of Supplementary Notes B1 to B3, in which in the text generation processing, the at least one processor generates a text describing a trajectory of the target based on output data obtained by inputting input data including the tracking result, the environmental information, and the spatial information to a large-scale language model.

### (Supplementary Note B5)

The information processing method according to Supplementary Note B4, in which in the text generation processing, the at least one processor searches for a trajectory similar to a trajectory of the target tracked by the target tracking processing from a storage device that stores a trajectory of a target observed in the past and environmental information in association with each other, and includes environmental information relevant to the searched trajectory in the input data.

### (Supplementary Note B6)

The information processing method according to Supplementary Note B5, in which in the text generation processing, the at least one processor stores an answer text, obtained by inputting a trajectory of a target observed in the past and environmental information into a large-scale language model, in the storage device in association with the trajectory of the target observed in the past and environmental information relevant to the trajectory, and a past answer text stored in association with the searched trajectory is included in the input data.

### (Supplementary Note B7)

The information processing method according to Supplementary Note B2, further including:
label assigning processing of assigning, by the at least one processor, a label indicating an importance to a trajectory of the target obtained by tracking in the target tracking processing; and
training processing of training, by the at least one processor, a learning model using training data including the labeled trajectory and the environmental information, the learning model having the trajectory and the environmental information as inputs, and an importance of the target trajectory as an output,
in which in the importance calculation processing, the at least one processor calculates the importance using the learning model.

### (Supplementary Note B8)

The information processing method according to Supplementary Note B7, in which in the label assigning processing, the at least one processor extracts a word/phrase relevant to an important trajectory from a text representing an utterance voice of a user, selects a trajectory relevant to the extracted word/phrase from among the plurality of trajectories, and assigns a label indicating the importance to the selected trajectory.

### (Supplementary Note B9)

The information processing method according to Supplementary Note B2, B7, or B8, in which in the text generation processing, the at least one processor generates a text describing the trajectory using an image output in the output processing in addition to the tracking result, the environmental information, and the spatial information.

### (Supplementary Note B10)

An information processing method according to Supplementary Note B3, further including:
voice acquisition processing of acquiring, by the at least one processor, voice data representing an utterance voice of a user; and
text conversion processing of converting, by the at least one processor, the voice data into a text,
in which in the text generation processing, the at least one processor generates a text describing the trajectory using a text converted by the text conversion processing in addition to the tracking result, the environmental information, and the spatial information.

### (Supplementary Note B11)

An information processing method including:
target detection processing of detecting, by at least one processor, a target existing in a space using sensor information;
target tracking processing of tracking, by the at least one processor, the target detected in the target detection processing;
label assigning processing of assigning, by the at least one processor, a label indicating the importance to the trajectory of the target obtained by tracking in the target tracking processing; and
training processing of training, by the at least one processor, a learning model in which the trajectory and the environmental information are input and the importance of the trajectory is output using the training data including the trajectory labeled by the label assigning processing and the environmental information regarding the environment of the target.

### [Supplementary Note C]

The present disclosure includes technologies described in the following Supplementary Notes. However, the present invention is not limited to the technologies described in the following Supplementary Notes, and various modifications can be made within the scope described in the claims.

### (Supplementary Note C1)

An information processing program for causing a computer to function as an information processing apparatus, the program causing the computer to function as:
a target detection means for detecting a target existing in a space using sensor information indicating a sensing result by a sensor configured to sense the space;
a target tracking means for tracking a target detected by the target detection means;
a text generation means for generating a text describing a trajectory of the target using a tracking result by the target tracking means, environmental information regarding an environment of the target, and spatial information indicating the space; and
an output means for outputting an image representing a trajectory of the target in the space and a text generated by the text generation means.

### (Supplementary Note C2)

The information processing program according to Supplementary Note C1, the program further causing the computer to function as:
an importance calculation means for calculating an importance of each of a plurality of trajectories obtained by tracking by the target tracking means; and
a selection means for selecting, from among the plurality of trajectories, a trajectory having an importance higher than that of another target, in which
the text generation means generates a text describing the trajectory using a trajectory selected by the selection means, the environmental information, and the spatial information, and
the output means outputs an image in which the trajectory selected by the selection means is enhanced more than other trajectories, and a text generated by the text generation means.

### (Supplementary Note C3)

The information processing program according to Supplementary Note C1 or C2, in which the text generation means generates a text describing a trajectory of the target using a text representing an utterance voice of a user in addition to the tracking result, the environmental information, and the spatial information.

### (Supplementary Note C4)

The information processing program according to any one of Supplementary Notes C1 to C3, in which the text generation means generates a text describing a trajectory of the target based on output data obtained by inputting input data including the tracking result, the environmental information, and the spatial information to a large-scale language model.

### (Supplementary Note C5)

The information processing program according to Supplementary Note C4, in which the text generation means searches for a trajectory similar to a trajectory of the target tracked by the target tracking means from a storage device that stores a trajectory of a target observed in the past and environmental information in association with each other, and includes environmental information relevant to the searched trajectory in the input data.

### (Supplementary Note C6)

The information processing program according to Supplementary Note C5, in which the text generation means stores an answer text, obtained by inputting a trajectory of a target observed in the past and environmental information into a large-scale language model, in the storage device in association with the trajectory of the target observed in the past and environmental information relevant to the trajectory, and a past answer text stored in association with the searched trajectory is included in the input data.

### (Supplementary Note C7)

The information processing program according to Supplementary Note C2, the program further causing the computer to function as:
a label assigning means for assigning a label indicating an importance to a trajectory of the target obtained by tracking by the target tracking means; and
a training means for training a learning model using training data including the labeled trajectory and the environmental information, the learning model having the trajectory and the environmental information as inputs, and an importance of the target trajectory as an output,
in which the importance calculation means calculates the importance using the learning model.

### (Supplementary Note C8)

The information processing program according to Supplementary Note C7, in which the label assigning means extracts a word/phrase relevant to an important trajectory from a text representing an utterance voice of a user, selects a trajectory relevant to the extracted word/phrase from among the plurality of trajectories, and assigns a label indicating the importance to the selected trajectory.

### (Supplementary Note C9)

The information processing program according to Supplementary Note C2, C7 or C8, in which the text generation means generates a text describing the trajectory using an image output by the output means in addition to the tracking result, the environmental information, and the spatial information.

### (Supplementary Note C10)

The information processing program according to Supplementary Note C3, the program further causing the computer to function as:
a voice acquisition means for acquiring voice data representing an utterance voice of a user; and
a text conversion means for converting the voice data into a text,
in which the text generation means generates a text describing the trajectory using a text converted by the text conversion means in addition to the tracking result, the environmental information, and the spatial information.

### (Supplementary Note C11)

An information processing program for causing a computer to function as an information processing apparatus, the program causing the computer to function as:
a target detection means for detecting a target existing in a space using sensor information;
a target tracking means for tracking a target detected by the target detection means;
a label assigning means for assigning a label indicating an importance to a trajectory of the target obtained by tracking by the target tracking means; and
a training means for training a learning model using training data including a trajectory labeled by the label assigning means and environmental information regarding an environment of the target as inputs and an importance of the trajectory as an output.

### [Supplementary Note D]

The present disclosure includes technologies described in the following Supplementary Notes. However, the present invention is not limited to the technologies described in the following Supplementary Notes, and various modifications can be made within the scope described in the claims.

### (Supplementary Note D1)

An information processing apparatus including at least one processor, in which
the at least one processor executes:
target detection processing of detecting a target existing in a space using sensor information indicating a sensing result by a sensor that senses the space;
target tracking processing of tracking a target detected in the target detection processing;
text generation processing of generating a text describing a trajectory of the target using a tracking result by the target tracking processing, environmental information regarding an environment of the target, and spatial information indicating the space; and
output processing of outputting an image representing a trajectory of the target in the space and a text generated in the text generation processing.

The information processing apparatus may further include a memory. The memory may store a program for causing the at least one processor to execute each of the processing.

### (Supplementary Note D2)

The information processing apparatus according to Supplementary Note D1, in which
the at least one processor further executes:
importance calculation processing of calculating an importance of each of a plurality of trajectories obtained by tracking in the target tracking processing; and
selection processing of selecting, from among the plurality of trajectories, a trajectory having an importance higher than that of another target,
in the text generation processing, the at least one processor generates a text describing the trajectory using a trajectory selected in the selection processing, the environmental information, and the spatial information, and
in the output processing, the at least one processor outputs an image in which the trajectory selected in the selection processing is enhanced more than other trajectories, and a text generated in the text generation processing.

### (Supplementary Note D3)

The information processing apparatus according to Supplementary Note D1 or D2, in which in the text generation processing, the at least one processor generates a text describing a trajectory of the target using a text representing an utterance voice of a user in addition to the tracking result, the environmental information, and the spatial information.

### (Supplementary Note D4)

The information processing apparatus according to any one of Supplementary Notes D1 to D3, in which in the text generation processing, the at least one processor generates a text describing a trajectory of the target based on output data obtained by inputting input data including the tracking result, the environmental information, and the spatial information to a large-scale language model.

### (Supplementary Note D5)

The information processing apparatus according to Supplementary Note D4, in which in the text generation processing, the at least one processor searches for a trajectory similar to a trajectory of the target tracked by the target tracking processing from a storage device that stores a trajectory of a target observed in the past and environmental information in association with each other, and includes environmental information relevant to the searched trajectory in the input data.

### (Supplementary Note D6)

The information processing apparatus according to Supplementary Note D5, in which in the text generation processing, the at least one processor stores an answer text, obtained by inputting a trajectory of a target observed in the past and environmental information into a large-scale language model, in the storage device in association with the trajectory of the target observed in the past and environmental information relevant to the trajectory, and a past answer text stored in association with the searched trajectory is included in the input data.

### (Supplementary Note D7)

The information processing apparatus according to Supplementary Note D2, in which
the at least one processor further executes:
label assigning processing of assigning a label indicating an importance to a trajectory of the target obtained by tracking in the target tracking processing; and
training processing of training a learning model using training data including the labeled trajectory and the environmental information, the learning model having the trajectory and the environmental information as inputs, and an importance of the target trajectory as an output, and
in the importance calculation processing, the at least one processor calculates the importance using the learning model.

### (Supplementary Note D8)

The information processing apparatus according to Supplementary Note D7, in which in the label assigning processing, the at least one processor extracts a word/phrase relevant to an important trajectory from a text representing an utterance voice of a user, selects a trajectory relevant to the extracted word/phrase from among the plurality of trajectories, and assigns a label indicating the importance to the selected trajectory.

### (Supplementary Note D9)

The information processing apparatus according to Supplementary Note D2, D7, or D8, in which in the text generation processing, the at least one processor generates a text describing the trajectory using an image output in the output processing in addition to the tracking result, the environmental information, and the spatial information.

### (Supplementary Note D10)

An information processing apparatus according to Supplementary Note D3, in which
the at least one processor further executes:
voice acquisition processing of acquiring, by the at least one processor, voice data representing an utterance voice of a user; and
text conversion processing of converting the voice data into a text, and
in the text generation processing, the at least one processor generates a text describing the trajectory using a text converted by the text conversion processing in addition to the tracking result, the environmental information, and the spatial information.

### (Supplementary Note D11)

An information processing apparatus including at least one processor, in which
the at least one processor executes:
target detection processing of detecting a target existing in a space using sensor information;
target tracking processing of tracking the target detected in the target detection processing;
label assigning processing of assigning a label indicating the importance to the trajectory of the target obtained by tracking in the target tracking processing; and
training processing of training a learning model in which the trajectory and the environmental information are input and the importance of the trajectory is output using the training data including the trajectory labeled by the label assigning processing and the environmental information regarding the environment of the target.

### [Supplementary Note E]

The present disclosure includes technologies described in the following Supplementary Notes. However, the present invention is not limited to the technologies described in the following Supplementary Notes, and various modifications can be made within the scope described in the claims.

### (Supplementary Note E1)

A non-transitory recording medium having stored therein an information processing program for causing a computer to function as an information processing apparatus, the program causing the computer to execute:
target detection processing of detecting a target existing in a space using sensor information indicating a sensing result by a sensor configured to sense the space;
target tracking processing of tracking a target detected in the target detection processing;
text generation processing of generating a text describing a trajectory of the target using a tracking result by the target tracking processing, environmental information regarding an environment of the target, and spatial information indicating the space; and
output processing of outputting an image representing a trajectory of the target in the space and a text generated in the text generation processing.

### (Supplementary Note E2)

A non-transitory recording medium having stored therein an information processing program for causing a computer to function as an information processing apparatus, the program causing the computer to execute:
target detection processing of detecting a target existing in a space using sensor information;
target tracking processing of tracking a target detected in the target detection processing;
label assigning processing of assigning a label indicating an importance to a trajectory of the target obtained by tracking in the target tracking processing; and
training processing of training a learning model using training data including a trajectory labeled by the label assigning processing and environmental information regarding an environment of the target as inputs and an importance of the trajectory as an output.

1. An information processing apparatus comprising:
at least one memory storing instructions; and
at least one processor configured to execute the instructions to;
detect a target existing in a space using sensor information indicating a sensing result by a sensor configured to sense the space;
track a target detected by the target detection means;
generate a text describing a trajectory of the target using a tracking result by the target tracking means, environmental information regarding an environment of the target, and spatial information indicating the space; and
output an image representing a trajectory of the target in the space and a text generated.

2. The information processing apparatus according to claim 1, wherein the at least one processor is further configured to execute the instructions to:
calculate an importance of each of a plurality of trajectories obtained by tracking;
select, from among the plurality of trajectories, a trajectory having an importance higher than that of another target;
generate a text describing the trajectory using a trajectory selected by the selection means, the environmental information, and the spatial information; and
output an image in which the trajectory selected by the selection means is enhanced more than other trajectories, and a text generated.

3. The information processing apparatus according to claim 1, wherein the at least one processor is further configured to execute the instructions to:
generate a text describing a trajectory of the target using a text representing an utterance voice of a user in addition to the tracking result, the environmental information, and the spatial information.

4. The information processing apparatus according to claim 1, wherein the at least one processor is further configured to execute the instructions to:
generate a text describing a trajectory of the target based on output data obtained by inputting input data including the tracking result, the environmental information, and the spatial information to a large-scale language model.

5. The information processing apparatus according to claim 4, wherein the at least one processor is further configured to execute the instructions to:
search for a trajectory similar to a trajectory of the target tracked from a storage device that stores a trajectory of a target observed in the past and environmental information in association with each other; and
include environmental information relevant to the searched trajectory in the input data.

6. The information processing apparatus according to claim 5, wherein the at least one processor is further configured to execute the instructions to:
store an answer text, obtained by inputting a trajectory of a target observed in the past and environmental information into a large-scale language model, in the storage device in association with the trajectory of the target observed in the past and environmental information relevant to the trajectory; and
include a past answer text stored in association with the searched trajectory in the input data.

7. The information processing apparatus according to claim 2, wherein the at least one processor is further configured to execute the instructions to:
assigning a label indicating an importance to a trajectory of the target obtained; and
train a learning model using training data including the labeled trajectory and the environmental information, the learning model having the trajectory and the environmental information as inputs, and an importance of the target trajectory as an output; and
calculate the importance using the learning model.

8. The information processing apparatus according to claim 7, wherein the at least one processor is further configured to execute the instructions to:
extract a word/phrase relevant to an important trajectory from a text representing an utterance voice of a user, selects a trajectory relevant to the extracted word/phrase from among the plurality of trajectories; and
assign a label indicating the importance to the selected trajectory.

9. The information processing apparatus according to claim 2, wherein the at least one processor is further configured to execute the instructions to:
generate a text describing the trajectory using an image output in the output processing in addition to the tracking result, the environmental information, and the spatial information.

10. An information processing method comprising:
target detection processing of detecting, by at least one processor, a target existing in a space using sensor information indicating a sensing result by a sensor that senses the space;
target tracking processing of tracking, by the at least one processor, a target detected in the target detection processing;
text generation processing of generating, by the at least one processor, a text describing a trajectory of the target using a tracking result by the target tracking processing, environmental information regarding an environment of the target, and spatial information indicating the space; and
output processing of outputting, by the at least one processor, an image representing a trajectory of the target in the space and a text generated in the text generation processing.

11. A non-transitory recording medium stored therein an information processing program for causing a computer to function as an information processing apparatus, the program causing the computer to execute:
target detection processing of detecting a target existing in a space using sensor information;
target tracking processing of tracking a target detected in the target detection processing;
label assigning processing of assigning a label indicating an importance to a trajectory of the target obtained by tracking in the target tracking processing; and
training processing of training a learning model using training data including a trajectory labeled by the label assigning processing and environmental information regarding an environment of the target as inputs and an importance of the trajectory as an output.
